(19) United States
(12) Patent Application Publication
(10) Pub. No.: US 2006/0171057 A1
(43) Pub. Date: Aug. 3, 2006

(54) Method, medium, and apparatus for processing defects of an HDD

(75) Inventor: Hae-jung Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/344,161

(22) Filed: Feb. 1, 2006

(30) Foreign Application Priority Data
Feb. 2, 2005 (KR) 10-2005-0009682

(51) Int. Cl. G11B 15/18

(52) U.S. Cl. 360/69

(57) ABSTRACT

A reassigning method, medium, and apparatus for processing latent defects of a hard disc drive (HDD). The method of processing defects in an HDD may includes detecting latent defects that may develop into irrecoverable defects in the future, registering the detected latent defects in a temporary list, and replacing the latent defects registered in the temporary list by normal sectors when the HDD is in an idle state. Accordingly, performance and reliability of HDDs can be improved by such detecting of latent and reassigning the latent defects before they develop into actual defects.

### CROSS-REFERENCE TO RELATED APPLICATIONS

This application claims the priority benefit of Korean Patent Application No. 10-2005-0009682, filed on Feb. 2, 2005, in the Korean Intellectual Property Office, the disclosure of which is incorporated herein in its entirety by reference.

### BACKGROUND OF THE INVENTION

1. Field of the Invention

Embodiments of the present invention relate to a method, medium, and apparatus for managing defects of a hard disc drive (HDD), and more particularly, to a method, medium, and apparatus for pre-detecting of a latent defect that can may develop into a defect in the future in a user environment and for reassigning the detected latent defect.

2. Description of the Related Art

A hard disc drive (HDD) is a magnetic recording device used for storing and/or reproducing information. The HDD may include a plurality of discs (typically called media), where the information may be written on concentric tracks formed on surfaces of the discs. Each track of the discs may be partitioned into blocks called sectors for storing and seeking data in a regulative way. Location information of the sectors may be represented by unique identifiers, such as cylinder (or track) numbers, head (a device for accessing surfaces of the discs) numbers, and sector numbers, for example.

The discs may be combined with a spindle motor, such that the information is accessible by read/write heads attached to an actuator arm of the HDD.

On the discs, defects exist along portions of the discs where the information cannot be read from or written to. The discs may have preexisting defects, e.g., a defects in the disc itself, or defects may be generated during a manufacturing process or while being used by user, for example.

A defective sector cannot be used to write or read data. Thus, prior to release to resultant users, manufacturer usually detect defects and replace the defects with normal sectors, thereby providing apparent defect-free discs to users.

The manufacturing process of HDDs may include a burn-in test. In the burn-in test, whether a defect exists and locations of the same may be detected by repeatedly performing read/write tests while varying data patterns and write/read conditions. A user is thereafter prevented from accessing the defective areas by an implemented listing of the location (cylinder, head and sector) of each of the defects and error codes, obtained from the burn-in test, e.g., in a login list.

However defects may also be generated in a user environment, e.g., after the HDDs are put into the market. If, during user operation, a detected error is not compensated/recovered, even through a retry process, the sector in which the error occurred may be determined to be defective, and defect processing to replace the defective sector with a normal sector may be performed.

Regardless of physical discontinuity of sectors due to such defects, sector addresses to access sectors should seem continuous. Accordingly, a process of replacing defective sectors by normal sectors becomes necessary, called defect processing.

The defect processing can be done in different ways, representatively a slip method and a reassign method, for example.

The slip method is mainly used for defects detected during the burn-in test, and the reassign method is mainly used for defects detected in the user environment.

The slip method and the reassign method may be common in their respective use of spare areas while they may be different in that the slip method replaces a defective sector by a subsequent sector while the reassign method replaces the defective sector with a sector in the spare area.

Defects in the user environment may be classified into: 1) a defused defect caused by a diffusion of existing defects, in particular, occurred by scratches, for example; 2) grown defects; and 3) additive defects due to fine particles or head-disc interference (HDI).

Scratches may cause damage to a magnetic recording layer, which may be diffused in a direction of the scratch. Thus, defects due to scratches need to be continually managed even after the original defect processing has been completed.

The grown defect may be a defect that occurs over time due to long use in the user environment, even if these defects were not detected in the original defect processing process during manufacturing.

The additive defects may be defects that are generated due to fine particles that intrude into the internal HDD environment during user use and/or the HDI, etc.

Typically, defect processing in the user environment may be performed when a defect is detected, i.e., when a sector on which a reading/writing operation becomes impossible or impractical. In detail, when a read/write error is generated, an error recovery may be tried using a retry operation. If the error recovery becomes impossible or impractical, the defect processing is then performed to identify the error as a defect.

However, the conventional defect processing method is processed after the read/write error is generated. Accordingly, serious problems may still occur due to poor timing of defect generation.

Recently, HDDs have become popular not just as simple storage media but also as a kind of essential device for storing various application programs as well as various operating systems. As an example, if an HDD is used to access an operating system and application programs in real-time, data integrity becomes an important factor.

Assuming that a defect is generated between two access time points in the same sector, according to the conventional defect processing method, defect processing of the sector is not performed before the actual defect is generated. Accordingly, since the sector cannot be read after the defect was generated, execution of a program may stop, or a system may stop, for example.

Therefore, there is a need for data integrity by detecting sectors that may generate defects in the future, e.g., in the user environment, and preparing an appropriate countermeasure against the same.

### SUMMARY OF THE INVENTION

Embodiments of the present invention provide a defect processing method, medium, and apparatus for improving reliability of a hard disc drive (HDD) by detecting latent defects which may generate defects in the future and performing defect processing of the latent defects before generation of the respective defects.

To achieve the above and/or other aspects and advantages, embodiments of the present invention include a method of processing defects in a hard disc drive (HDD), including detecting latent defects that may develop into defects at a future time, and replacing the latent defects with alternative areas.

The alternative areas may be alternative sectors. In addition, the replacing of the latent defects may be performed when the HDD is in an idle state.

The method of processing defects may be performed in a user environment, and the replacing of the latent defects may be performed through a reassignment of data from an area of the latent defect to an alternative area.

Further, in the detecting of the latent defects, each of the latent defects may be determined by examining for a generation of thermal asperity (TA), for a change of a sectional auto gain control (AGC), and/or for whether an error for a corresponding evaluated area has previously been recovered, by a repeated retry operation more than a predetermined number of times.

In addition, the method may further include registering the detected latent defects in a temporary list, wherein the replacing of the latent defects is performed based on the temporary list.

Further, the method may include determining whether a target sector in which data is to be recorded is registered in the temporary list when a write command is received by the HDD, reassigning the target sector to an alternate sector if the target sector is registered in the temporary list, and writing the data in the reassigned alternate sector.

The replacing of the latent defects may also be performed during a manufacturing stage before a user environment stage.

To achieve the above and/or other aspects and advantages, embodiments of the present invention include a hard disc drive (HDD), including a read/write circuit to perform data processing to write data on a disc and/or read data from the disc, and a controller to determine whether latent defects have been generated by referring to an auto gain control (AGC) signal, a thermal asperity (TA) detection signal, and/or an indication of a retry operation having been performed more than a predetermined number of times, for an evaluated area of the disc, and to perform defect processing of the latent defects, wherein the controller detects latent defects that may develop into defects at a future time.

The HDD may further include a host interface to perform data transmission/reception processing with a host device a memory to store therein firmware and control information to control the HDD, and a buffer to store data received from the host device through the host interface in a write mode and to store data reproduced from the disc in a read mode.

Further, the controller may perform the defect processing of the latent defects when the HDD is in an idle state.

In addition, the controller may determine whether the latent defects have been generated by examining for a generation of thermal asperity (TA), for a change of a sectional auto gain control (AGC), and/or a positive indication of the retry operation having been performed more than the predetermined number of times.

The controller may further register the detected latent defects in a temporary list. Here, if a write command is received by the HDD, the controller may determine whether a target sector in which data is to be recorded is registered in the temporary list, reassign the target sector if the target sector is registered in the temporary list, and write the data in the reassigned target sector.

To achieve the above and/or other aspects and advantages, embodiments of the present invention include a medium including computer readable code to implement a method of processing defects in a hard disc drive (HDD), the method including detecting latent defects that may develop into defects at a future time, and replacing the latent defects with alternative areas.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a defect processing method, according to an embodiment of the present invention;

FIG. 2 illustrates a waveform showing the influence of thermal asperity (TA);

FIG. 3 illustrates a waveform showing the generation of a sectional AGC for a potential latent defect;

FIG. 4 illustrates an HDD, according to an embodiment of the present invention; and

FIG. 5 illustrates an electric system to control an HDD, such as that shown in FIG. 4, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

Defects on a disc, which may actually be generated by physical damage to a magnetic layer, e.g., where information is stored, may be classified into recoverable defects, which can be recovered using various recovery functions such as error correction code (ECC) and retry operations, and an irrecoverable defect, which cannot be permanently recovered, e.g., because of it's the defect degree.

The recoverable defect may be recovered by error recovery operations at the time when the defect is detected/generated and for a while after the defect was detected/generated, however, the recoverable defects frequently cause errors and may gradually become irrecoverable defects.

In embodiments of the present invention, by reassigning defects (hereinafter, latent defects) having a high probability of later being determined as being a defect, e.g., in a next access, among recoverable defects, locations corresponding to the latent defects may not be used again/any more.

As a method of predicting latent defects, the three following cases have been found important:

1) The generation of thermal asperity (TA);

2) The change of a sectional automatic gain control (AGC) greater than a predetermined AGC threshold; and

3) The case where an error is repeatedly recovered by a repeating of the retry operation, more than a predetermined number of times.

Accordingly, in such situations, a reassigning of the latent defects may be performed: 1) when a hard disc drive (HDD) is in an idle state; or 2) when a write command is performed, for example.

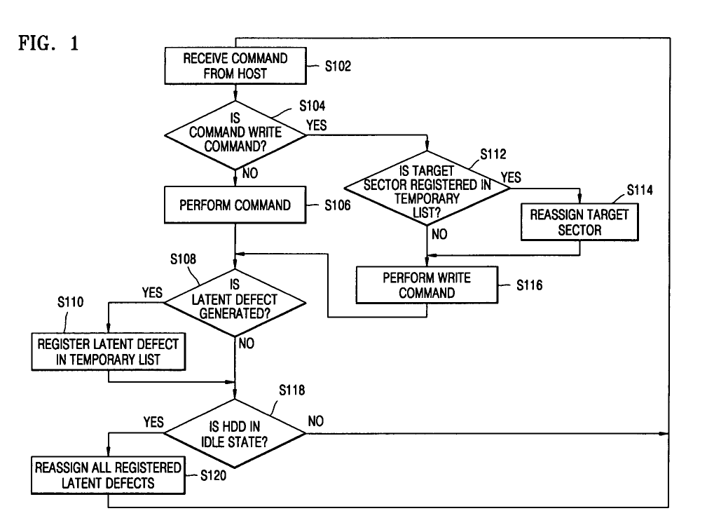

FIG. 1 illustrates a defect processing method, according to an embodiment of the present invention.

Referring to FIG. 1, a command may be received from a host device, in operation S102, at which time whether the received command is a write command may be determined, in operation S104. If the received command is not a write command, the received command may be performed, in operation S106. Alternatively, for example, whether a latent defect has been generated may then be determined, in operation S108.

Whether the latent defect, in the user environment, is generated may be determined by at least the aforementioned three cases, i.e., the generation of TA, the change of a sectional AGC more than a predetermined AGC threshold, and the case where an error is repeatedly recovered by a repeating of a retry operation more than a predetermined number of times.

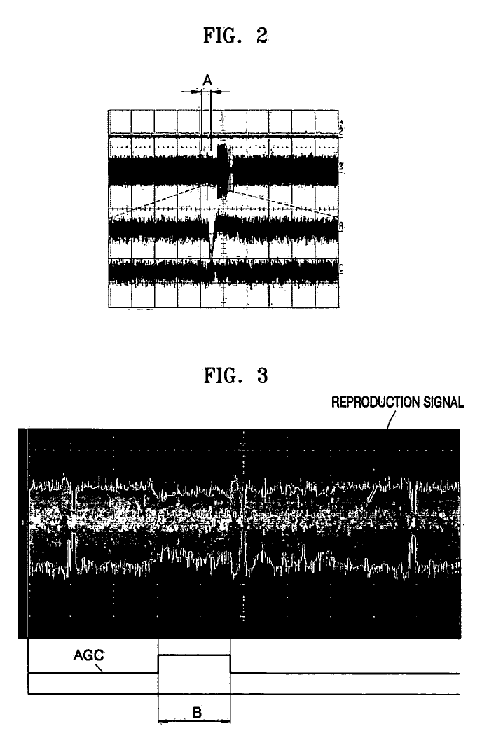

FIG. 2 illustrates a waveform diagram showing an influence of the TA. Referring to FIG. 2, the duration A in the top waveform is a duration on which the TA was generated, the middle waveform shows an enlargement of the duration A, and the bottom waveform is a waveform corresponding to the case where the TA has not been generated.

The TA is signal distortion caused by heat generated by physical contacts between a head and a disc. Since the size of the portion in which the TA is generated is small, the TA-based defect may typically be recovered using an ECC operation in a first state. However, the possibility of the defect becoming irrecoverable in the future is high because the size of the TA influenced portion may increase over time.

FIG. 3 illustrates a waveform diagram showing the generation of a sectional AGC. Referring to FIG. 3, a signal generated by a head is shown along the top of FIG. 3, and an AGC signal corresponding to the signal is shown along the bottom of FIG. 3. Here, an AGC operation is an operation outputting a signal having a constant magnitude even if the magnitude of an input signal varies. HDDs have adopted the AGC operation so that a read channel can provide a signal having a constant magnitude even if the magnitude of a corresponding signal generated by a head varies. Thus, the magnitude of an AGC signal indicates a gain of an AGC circuit and is inversely proportional to the magnitude of an input signal. That is, a high gain is set for an input signal having a small magnitude, and a low gain is set for an input signal having a large magnitude.

According to an embodiment of the present embodiment, to predict recoverable defects, latent defects may be detected either when the AGC is higher or when the AGC is lower than a predetermined criterion, compared to a previous sector, such that sectors at the latent defect locations may be reassigned. That is, the reassign processing may be performed upon detection of the AGC being sectionally changed more than the predetermined criterion, such as section B of FIG. 3.

A retry operation is an operation of recovering a read/write error by performing reading/writing operations while changing various channel parameters when a read/write error is generated. In the case where the error is repeatedly recovered by performing the retry for more than a predetermined number of times, since the probability of a future error is high, the reassigning processing of a defected sector corresponding to the error may be performed.

If the latent defect is detected, in operation S108, the latent defect may be registered in a temporary list, in operation S110.

If the command received from the host device is determined to be a write command, in operation S104, whether a target sector is registered in the temporary list may then be determined, in operation S112.

If the target sector is registered in the temporary list, the target sector may then be reassigned, in operation S114. Then, the reassigned defect may be erased from the temporary list, for example.

Thus, data may then be written in the target sector or the reassigned sector, in operation S116, and the process may proceed to operation S108.

According to another embodiment of the present invention, whether the HDD is in an idle state may be determined in operation S118.

An idle state may be a state in which no command has been received from the external host device to the HDD for a predetermined time, for example.

If the HDD is in an idle state, the HDD may then reassign sectors registered in the temporary list, in operation S120. As the result of reassigning process, the latent defects may not be used thereafter.

If the HDD is not in the idle state, the process may proceed to operation S102, waiting for a command from the host device, for example.

According to embodiments of the present invention, performance and reliability of HDDs can be improved by detecting latent defects and defect processing the latent defects in advance to the latent defects becoming actual defects.

In addition, according to embodiments of the present invention, it is further noted such above embodiments may further be implemented not only in a user environment but also in a manufacturing process of HDDs.

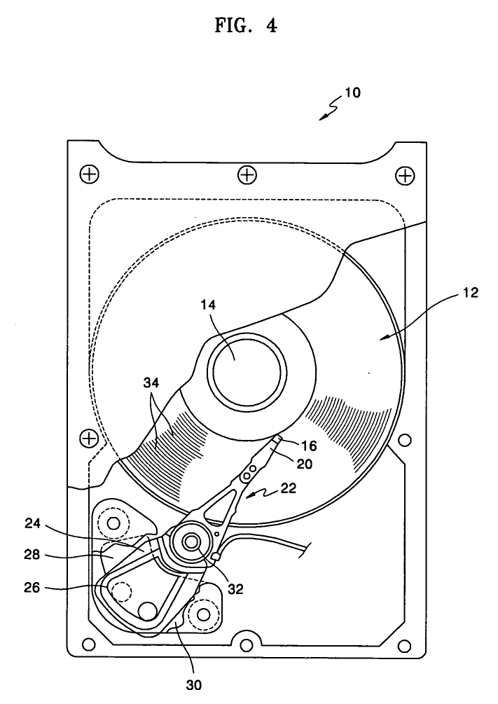

FIG. 4 illustrates an HDD 10, according to an embodiment of the present invention. Referring to FIG. 4, the HDD 10 may include at least one disc 12 to be rotated by a spindle motor 14 and a transducer 16 adjacently located on a surface of a disc 12.

The transducer 16 may read and/or write information from/to the disc 12 by sensing a magnetic field formed along a portion of the disc 12 or magnetizing a portion of the disc 12. Typically, the transducer 16 may be arranged along a surface of each disc 12. Though a single transducer 16 is shown in FIG. 4, the transducer 16 may include a write transducer, which magnetizes the portion of the disc 12, and a read transducer, which senses a magnetic field of the portion of the disc 12. The read transducer may also be composed of a magneto-resistive (MR) component.

The transducer 16 may be combined with a slider 20, with the slider 20 generating an air bearing between the transducer 16 and the surface of the disc 112. The slider 20 may be combined with a head gimbal assembly (HGA) 22, with the HGA 22 being attached to an actuator arm 24 having a voice coil 26. Here, the voice coil 26 may be located adjacent to a magnetic assembly 28 specifying (supporting) a voice coil motor (VCM) 30. The current supplied to the voice coil 26 can generate a torque, which rotates the actuator arm 24 around a bearing assembly 32. The rotation of the actuator arm 24 may then move the transducer 16 across the surface of the disc 12.

Information may be stored in concentric tracks of the disc 12. In general, each track 34 may include a plurality of sectors, with each sector including a data field and an identification field, for example. The identification field may be made up of a gray code identifying sectors and tracks (cylinders). The transducer 16, thus, may move across the surface of the disc 12 to read and/or write information from/to another track. Here, as an embodiment of the present invention, the HDD may implement the aforementioned embodiments.

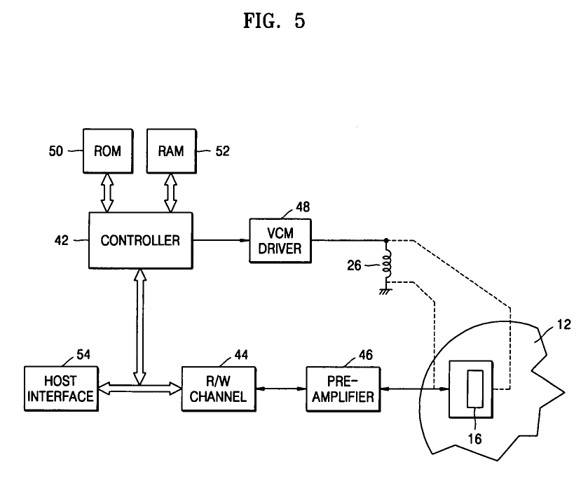

FIG. 5 illustrates an electric system 40 to control a HDD 10, such as that shown in FIG. 4. Referring to FIG. 5, the electric system 40 may include a controller 42 that is connected with the transducer 16 through a read/write (RAN) channel 44 and a read pre-amplifier 46. The controller 42 may be a digital signal processor (DSP), a microprocessor or a micro-controller, for example. The controller 42 may provide a control signal to the RAN channel 44 to read data from the disc 12 and/or write data on the disc 12. Information may typically be transmitted from the R/W channel 44 to a host interface circuit 54, with the host interface circuit 54 including a buffer memory and a control circuit, for example, which may allow the HDD 10 to interface other systems, such as a personal computer.

The controller 42 may be combined with a VCM driver 48 supplying a driving current to the voice coil 26, such that the controller 42 supplies a control signal to the VCM driver 148 to control activation of a VCM and a motion of the transducer 16.

The controller 42 may be connected to a nonvolatile memory, such as a read only memory (ROM) or a flash memory 50, and a random access memory (RAM) 52, for example. The memory devices 50 and 52 may, thus, store therein computer readable code, e.g., commands and data used by the controller 42 to execute software routines. The software routines may include a seek control routine for moving the transducer 16 from one track to another. The seek control routine may include a servo control routine for guaranteeing that the transducer 16 is moved to an exact track. As an embodiment, in the memory device 50, such computer readable code may be stored to implement embodiments of the present invention.

The controller 42 may determine whether latent defects, in a user environment, have been generated and may reassign the detected latent.

In detail, the controller 42 may determine whether latent defects have been generated by referring to TA, AGC, and/or a retry operation number of times, for example, and register the latent defects in a temporary list. In an idle state, the controller 42 may reassign the latent defects registered in the temporary list, e.g., all at once. The controller 42 may determine whether a target sector, in which data is written, is registered in the temporary list when a write command is received, and if the target sector is registered in the temporary list, the controller 42 may reassign the target sector and write the data in the reassigned sector.

The RAN channel 44 may detect whether the TA is generated, and if the TA is generated, the R/W channel 44 may generate a TA detection (TAD) signal. The controller 42 can may then determine whether a latent defect has been generated by determining whether the TAD signal has been generated. A criterion value for determining signal distortion, for determining in the RAN channel 44 whether the TA has been generated, may be set by the controller 42.

Embodiments of he present invention may be realized as a method, an apparatus, and/or a system. In addition, embodiments of the present invention may be realized as computer readable code, e.g., software components of the present invention embodied as code segments for executing required operations. The computer readable code may be stored/transferred in a medium, e.g., processor readable recording medium, and, for example, transmitted as computer data signals combined with a carrier using a transmission medium or a communication network. The medium may be any data storage device that can store and/or transmit data that can be thereafter read by a computer system, for example. Examples of media include electronic circuits, semiconductor memory devices, read-only memory (ROM), flash memory, erasable ROM, floppy disks, optical discs, hard discs, optical fibber media, and RF networks, for example. The computer data signals may further include any signal that can be propagated via transmission media such as electronic network channels, optical fibbers, air, electronic fields, and RF networks, for example.

As described above, according to embodiments of the present invention, performance and reliability of HDDs can be improved by detecting latent defects that may develop into defects in the future and reassigning the latent defects.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of processing defects in a hard disc drive (HDD), comprising:
detecting latent defects that may develop into defects at a future time; and
replacing the latent defects with alternative areas.

2. The method of claim 1, wherein the alternative areas are alternative sectors.

3. The method of claim 1, wherein the replacing of the latent defects is performed when the HDD is in an idle state.

4. The method of claim 1, wherein the method of processing defects is performed in a user environment, and the replacing of the latent defects is performed through a reassignment of data from an area of the latent defect to an alternative area.

5. The method of claim 1, wherein in the detecting of the latent defects, each of the latent defects is determined by examining for a generation of thermal asperity (TA), for a change of a sectional auto gain control (AGC), and/or for whether an error for a corresponding evaluated area has previously been recovered, by a repeated retry operation more than a predetermined number of times.

6. The method of claim 1, further comprising registering the detected latent defects in a temporary list, wherein the replacing of the latent defects is performed based on the temporary list.

7. The method of claim 1, further comprising:
determining whether a target sector in which data is to be recorded is registered in the temporary list when a write command is received by the HDD;
reassigning the target sector to an alternate sector if the target sector is registered in the temporary list; and
writing the data in the reassigned alternate sector.

8. The method of claim 1, wherein the replacing of the latent defects is performed during a manufacturing stage before a user environment stage.

9. A hard disc drive (HDD), comprising:
a read/write circuit to perform data processing to write data on a disc and/or read data from the disc; and
a controller to determine whether latent defects have been generated by referring to an auto gain control (AGC) signal, a thermal asperity (TA) detection signal, and/or an indication of a retry operation having been performed more than a predetermined number of times, for an evaluated area of the disc, and to perform defect processing of the latent defects,
wherein the controller detects latent defects that may develop into defects at a future time.

10. The HDD of claim 9, further comprising:
a host interface to perform data transmission/reception processing with a host device;
a memory to store therein firmware and control information to control the HDD; and
a buffer to store data received from the host device through the host interface in a write mode and to store data reproduced from the disc in a read mode.

11. The HDD of claim 9, wherein the controller performs the defect processing of the latent defects when the HDD is in an idle state.

12. The HDD of claim 9, wherein the controller determines whether the latent defects have been generated by examining for a generation of thermal asperity (TA), for a change of a sectional auto gain control (AGC), and/or a positive indication of the retry operation having been performed more than the predetermined number of times.

13. The HDD of claim 9, wherein the controller further registers the detected latent defects in a temporary list.

14. The HDD of claim 13, wherein if a write command is received by the HDD, the controller determines whether a target sector in which data is to be recorded is registered in the temporary list, reassigns the target sector if the target sector is registered in the temporary list, and writes the data in the reassigned target sector.

15. A medium comprising computer readable code to implement a method of processing defects in a hard disc drive (HDD), the method comprising:
detecting latent defects that may develop into defects at a future time; and
replacing the latent defects with alternative areas.

16. The medium of claim 15, wherein the alternative areas are alternative sectors.

17. The medium of claim 15, wherein the replacing of the latent defects is performed when the HDD is in an idle state.

18. The medium of claim 15, wherein the method further comprises registering the detected latent defects in a temporary list, wherein the replacing of the latent defects is performed based on the temporary list.

19. The medium of claim 18, wherein the method further comprises:
determining whether a target sector in which data is to be recorded is registered in the temporary list when a write command is received by the HDD;
reassigning the target sector to an alternate sector if the target sector is registered in the temporary list; and
writing the data in the reassigned alternate sector.
